(19) United States
(12) Patent Application Publication
(10) Pub. No.: US 2024/0105377 A1
(43) Pub. Date: Mar. 28, 2024

(54) MAGNETIC STRUCTURE AND MAGNETIC ELEMENT

(71) Applicant: Silergy Semiconductor Technology (Hangzhou) LTD, Hangzhou (CN)

(72) Inventors: Gao Fan, Hangzhou (CN); Yu Qi, Hangzhou (CN); Wei Chen, Hangzhou (CN)

(21) Appl. No.: 18/368,661

(22) Filed: Sep. 15, 2023

(30) Foreign Application Priority Data
Sep. 27, 2022 (CN) 202211179745.X

(51) Int. Cl. H01F 27/24; H01F 27/28

(52) U.S. Cl. CPC H01F 27/24; H01F 27/2823

(57) ABSTRACT

A magnetic structure can include: a first magnetic component and a second magnetic component; two magnetic columns configured to form a magnetic flux loop with at least part of the first magnetic component and at least part of the second magnetic component, where at least one of the two magnetic columns is wound with one or more windings; and where the at least part of the first magnetic component is located between the two magnetic columns.

### RELATED APPLICATIONS

This application claims the benefit of Chinese Patent Application No. 202211179745.X, filed on Sep. 27, 2022, which is incorporated herein by reference in its entirety.

### FIELD OF THE INVENTION

The present invention generally relates to the field of power electronics, and more particularly to magnetic structures and elements.

### BACKGROUND

A switched-mode power supply (SMPS), or a “switching” power supply, can include a power stage circuit and a control circuit. When there is an input voltage, the control circuit can consider internal parameters and external load changes, and may regulate the on/off times of the switch system in the power stage circuit. Switching power supplies have a wide variety of applications in modern electronics. For example, switching power supplies can be used to drive light-emitting diode (LED) loads.

### BRIEF DESCRIPTION OF THE DRAWINGS

FIG. 1 is a schematic sectional diagram of an example magnetic structure.

FIG. 2 is a schematic sectional diagram of a first example magnetic structure, in accordance with embodiments of the present invention.

FIG. 3 is a schematic sectional diagram of a second example magnetic structure, in accordance with embodiments of the present invention.

FIG. 4 is a schematic sectional diagram of a third example magnetic structure, in accordance with embodiments of the present invention.

FIG. 5 is a schematic sectional diagram of a fourth example magnetic structure, in accordance with embodiments of the present invention.

FIG. 6 is a schematic sectional diagram of a fifth example magnetic structure, in accordance with embodiments of the present invention.

FIG. 7 is a schematic structural diagram of a sixth example magnetic structure, in accordance with embodiments of the present invention.

FIG. 8 is a schematic sectional diagram of a seventh example magnetic structure, in accordance with embodiments of the present invention.

FIG. 9 is a schematic sectional diagram of an eighth example magnetic structure, in accordance with embodiments of the present invention.

FIG. 10 is a schematic sectional diagram of a ninth example magnetic structure, in accordance with embodiments of the present invention.

FIG. 11 is a top view of a tenth example magnetic structure, in accordance with embodiments of the present invention.

FIG. 12 is a schematic sectional diagram of an eleventh example magnetic structure, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

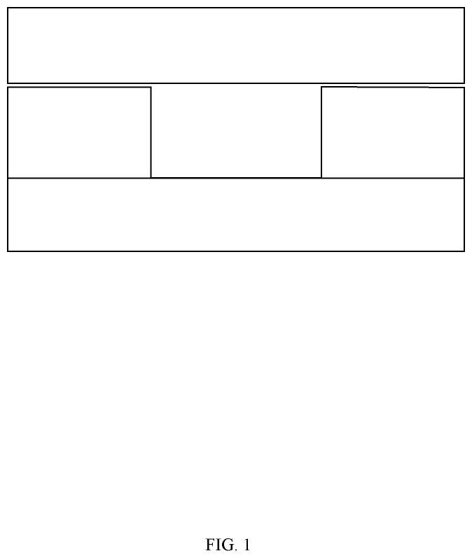

Referring now to FIG. 1, shown is a schematic sectional diagram of an example magnetic structure. In this particular example, the magnetic structure can include an I-shaped magnetic core and a U-shaped magnetic core. The I-shaped magnetic core can include an upper magnetic plate, and the U-shaped magnetic core can include a lower magnetic plate and two magnetic columns located above the lower magnetic plate. The upper magnetic plate can be located above the two magnetic columns. The flow direction of the magnetic flux in the I-shaped magnetic core can be different from that in the air gap between the overlapping surfaces of the U-shaped magnetic core and the I-shaped magnetic core. The flow directions of the magnetic flux of the two magnetic columns in the U-shaped magnetic core can be same as that in the air gap. Thus in this example, high magnetic flux can be generated in the I-type magnetic core due to refraction effect, which may cause uneven magnetic flux distribution and increase the local loss density of the magnetic core. The local accumulation of magnetic flux can be improved by thickening the thickness of I-type magnetic core. However, this may not be conducive to the miniaturization and flattening of the magnetic core, and may not be implemented in applications with relatively strict height restrictions.

Particular embodiments may provide a magnetic structure, which can include a first magnetic component and a second magnetic component, and two magnetic columns. At least one of the magnetic columns can be wound with one or more windings, and the two magnetic columns may form a magnetic flux loop with at least part of the first magnetic component and at least part of the second magnetic component. The at least part of the first magnetic component can be located between two magnetic columns. An air gap may be arranged between the magnetic column and the first magnetic component. The overlapping surfaces of the first magnetic component and the magnetic column can be matched, such that the overlapping surface of the first magnetic component and the magnetic column is a curved surface or a plane, or a combination of one or more curved surfaces and one or more plane, according to different shapes of the magnetic column. The two mutually matched surfaces of the first magnetic component and the magnetic column can be their respective overlapping surfaces. Optionally, the at least part of the second magnetic component may be located between two magnetic columns. The second magnetic component can be arranged similarly to the first magnetic component.

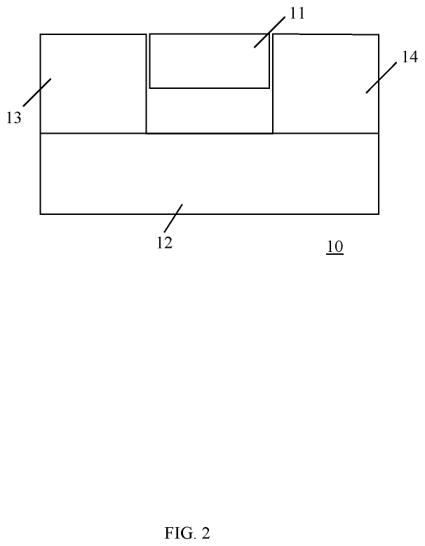

Referring now to FIG. 2, shown is a schematic sectional diagram of a first example magnetic structure, in accordance with embodiments of the present invention. In this particular example, magnetic structure 10 can include magnetic component 11, magnetic component 12, and two magnetic columns 13 and 14. At least one of two magnetic columns 13 and 14 can be wound with one or more windings, and two magnetic columns 13 and 14 may form a magnetic flux loop with magnetic components 11 and 12. Magnetic component 11 can be located between two magnetic columns 13 and 14. An air gap may be provided between two magnetic columns 13 and 14 and magnetic component 11. For example, the overlapping surface of the first magnetic component and the magnetic column is a plane. The overlapping surface can be perpendicular to the reference surface, and the reference surface can be perpendicular to the central axes of the two magnetic columns and pass through the two magnetic columns. In particular embodiments, the flow direction of magnetic flux in the air gap can be the same as that in the first magnetic component, but different from that in two magnetic columns. As such, the distribution of magnetic flux in the first magnetic component may essentially be uniform, and magnetic flux accumulation may occur in the magnetic column. The magnetic flux of the magnetic column can be uniformly distributed by increasing the width of the magnetic column. In addition, the thickness of the first magnetic component may not be changed, thus being beneficial to flattening, and can be applied to applications having strict height restrictions.

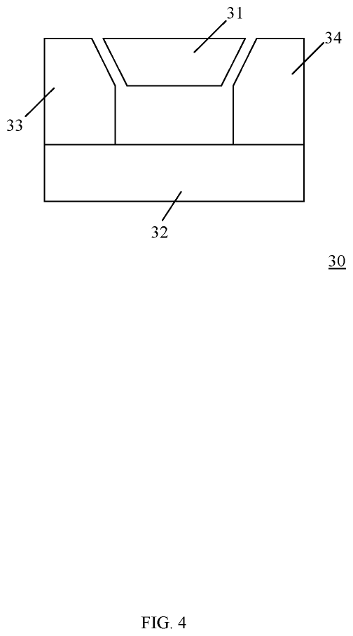

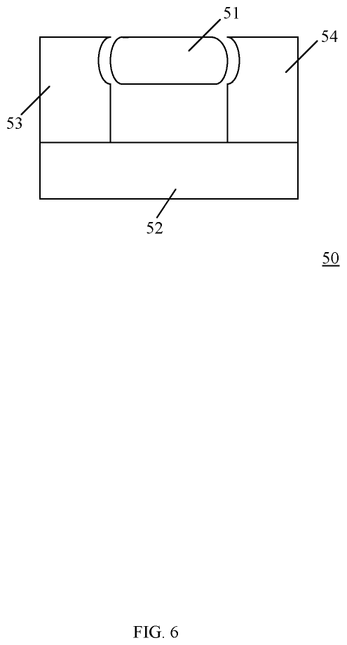

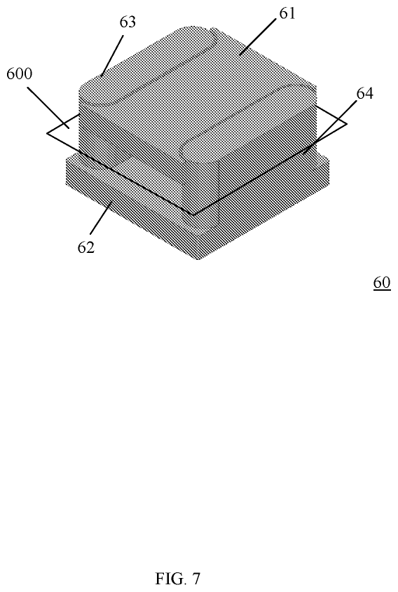

In particular embodiments, magnetic component 11 can include a first plane and a second plane, magnetic column 13 can include a third plane, and magnetic column 14 can include a fourth plane. The first plane can overlap with a part of the third plane, and the second plane may overlap with a part of the fourth plane. In other examples, the overlapping surface of the first magnetic component and one of the two magnetic columns can be a plane, and the overlapping surface of the first magnetic component and the other of the two magnetic column may have other structures, such as an inclined surface (see, e.g., FIG. 4), a curved surface (see, e.g., FIG. 6), or a combination of one or more curved surfaces and one or more planes (see, e.g., FIG. 7), to name just a few examples.

In particular embodiments, magnetic columns 13 and 14 can be located above magnetic component 12, and magnetic component 11 may be located between two magnetic columns 13 and 14. Magnetic component 12 and two magnetic columns 13 and 14 may form a U-shaped magnetic core, and magnetic component 11 can be an I-shaped magnetic core. In particular embodiments, magnetic component 12 and two magnetic columns 13 and 14 can be integrated. For example, air gaps may be provided between magnetic component 12 and two magnetic columns 13 and 14. For example, the largest surfaces in the first (e.g., 11) and second (e.g., 12) magnetic components can both be planes, and the central axes of the two magnetic columns along the same direction may be parallel. Also for example, the central axes of the two magnetic columns along the same direction may not be parallel. For example, the magnetic column can be an integral column. In particular embodiments, the magnetic column can include at least two sub-columns, and an air gap may be arranged between two adjacent sub-columns.

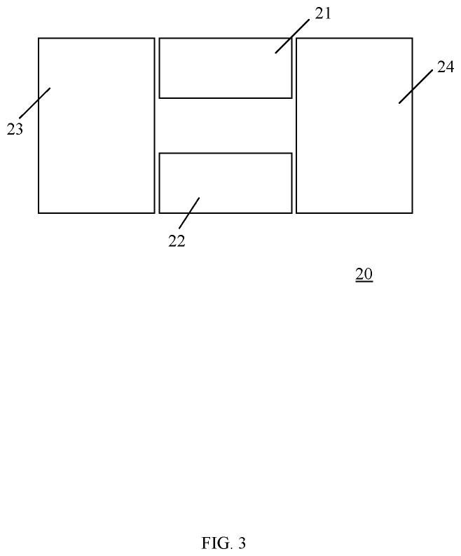

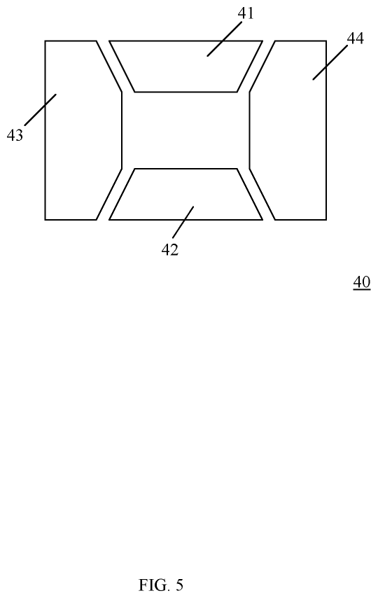

Referring now to FIG. 3, shown is a schematic sectional diagram of a second example magnetic structure, in accordance with embodiments of the present invention. In this particular example, magnetic structure 20 can include “second” magnetic component 22 located between two magnetic columns 23 and 24, which may be further beneficial to the flattening of the device. Air gaps can be provided between magnetic component 22 and two magnetic columns 23 and 24. In particular embodiments, magnetic component 22 can be arranged in the same way as the first magnetic component (e.g., 21), and the first and second magnetic components can be symmetrical. Also, the overlapping surfaces of the magnetic column and the first magnetic component, and the overlapping surfaces of the magnetic column and the second magnetic component, can be symmetrical. In other cases, the second magnetic component may have other structures (see, e.g., FIG. 5).

Referring now to FIG. 4, shown is a schematic sectional diagram of a third example magnetic structure, in accordance with embodiments of the present invention. In this particular example, magnetic structure 30 can include magnetic component 31, magnetic component 32, and two magnetic columns 33 and 34. At least one of two magnetic columns 33 and 34 can be wound with one or more windings, and two magnetic columns 33 and 34 may form a magnetic flux loop with magnetic components 31 and 32. Magnetic component 31 can be located between two magnetic columns 33 and 34. An air gap may be provided between each of two magnetic columns 33 and 34 and magnetic component 31. The overlapping surface of the first magnetic component (e.g., 31) and the magnetic column can be a plane (e.g., the overlapping surface is an inclined plane). The overlapping surface can intersect with a reference surface, and the reference surface can be perpendicular to the central axes of the two magnetic columns and pass through the two magnetic columns. For example included angle between the overlapping surface and the reference surface can be in a range of 5°-150°.

In particular embodiments, magnetic component 31 can include a first inclined plane and a second inclined plane, magnetic column 33 can include a third inclined plane, and magnetic column 34 can include a fourth inclined plane. The first inclined plane can overlap with the third inclined plane, and the second inclined plane may overlap with the fourth inclined plane. In other examples, the overlapping surface of the first magnetic component and one of the two magnetic column can be an inclined surface, and the overlapping surface of the first magnetic component and the other of the two magnetic columns may have other structures (see, e.g., FIG. 3). In particular embodiments, the first and second inclined planes may intersect after being extended, the first inclined plane can be parallel to the third inclined plane, and the second inclined plane may be parallel to the fourth inclined plane. In other examples, the first and second inclined planes can be parallel (e.g., the section of magnetic component 31 perpendicular to the reference plane is a parallelogram).

In particular embodiments, the section of magnetic component 31 perpendicular to the reference plane can be trapezoidal, and the projections of the first and second inclined planes on the section may form the waist of the trapezoid. The sections of magnetic columns 33 and 34 perpendicular to the reference plane can include pentagons, and the pentagons can include three right angles. Magnetic component 31 can be overlapped on the inclined surfaces of magnetic columns 33 and 34. In particular embodiments, the section of magnetic component 31 perpendicular to the reference plane may be trapezoidal. For example, the section of magnetic component 31 perpendicular to the reference plane may be a parallelogram or a triangle.

In particular embodiments, magnetic columns 33 and 34 can be located above magnetic component 32, and magnetic component 31 may be located between two magnetic columns 33 and 34. Magnetic component 32 and two magnetic columns 33 and 34 may form a U-shaped magnetic core, and magnetic component 31 can be an I-shaped magnetic core. For example, magnetic component 32 and two magnetic columns 33 and 34 are integrated. For example, an air gap may be provided between magnetic component 32 and each of two magnetic columns 33 and 34.

In particular embodiments, the largest surfaces in the first (e.g., 31) and second (e.g., 32) magnetic components may both be planes, and the central axes of the two magnetic columns along the same direction can be parallel. For example, the central axes of the two magnetic columns along the same direction may not be parallel. For example, the magnetic column can be an integral column. Also for example, the magnetic column can include at least two sub-columns, and an air gap may be arranged between two adjacent sub-columns.

Referring now to FIG. 5, shown is a schematic sectional diagram of a fourth example magnetic structure, in accordance with embodiments of the present invention. In this particular example, magnetic structure 40 can include magnetic component 42 located between magnetic columns 43 and 44. An air gap can be provided between magnetic component 42 and each of magnetic columns 43 and 44. In particular embodiments, magnetic component 42 may have the same arrangement as the first magnetic component (e.g., 41), and the second magnetic component (e.g., 42) and the first magnetic component can be symmetrical. Also, the overlapping surface of the magnetic column and the first magnetic component may be symmetrical with the overlapping surface of the magnetic column and the second magnetic component. Alternatively, the second magnetic component may have other structures (see, e.g., FIG. 3).

Referring now to FIG. 6, shown is a schematic sectional diagram of a fifth example magnetic structure, in accordance with embodiments of the present invention. In this particular example, magnetic structure 50 can include magnetic component 51, magnetic component 52, and two magnetic columns 53 and 54. At least one of two magnetic columns 53 and 54 can be wound with one or more windings, and magnetic columns 53 and 54 may form a magnetic flux loop with magnetic components 51 and 52. Magnetic component 51 can be located between two magnetic columns 53 and 54. An air gap may be provided between each of two magnetic columns 53 and 54 and magnetic component 51. The overlapping surface of the first magnetic component (e.g., 51) and the magnetic column can be a curved surface.

In particular embodiments, magnetic component 51 can include a first curved surface and a second curved surface, magnetic column 53 can include a third curved surface, and magnetic column 54 can include a fourth curved surface. The first curved surface can overlap with the third curved surface, and the second curved surface may overlap with the fourth curved surface. In one example, the overlapping surface of the first magnetic component and one of two magnetic columns can be a curved surface, and the overlapping surface of the first magnetic component and the other of two magnetic columns may have other structures (see, e.g., FIG. 3). Magnetic columns 53 and 54 can include three right angles, and magnetic component 51 may be overlapped on the curved surfaces of magnetic columns 53 and 54. Moreover, the first and second curved surfaces can be convex surfaces, and the third and fourth curved surfaces may be concave surfaces. For example, the first and second curved surfaces can be concave surfaces, and the third and fourth curved surfaces can be convex surfaces.

In particular embodiments, magnetic columns 53 and 54 can be located above magnetic component 52, and magnetic component 51 may be located between two magnetic columns 53 and 54. Magnetic component 52 and two magnetic columns 53 and 54 may form a U-shaped magnetic core, and magnetic component 51 can be an I-shaped magnetic core. In particular embodiments, magnetic component 52 and two magnetic columns 53 and 54 can be integrated. In other examples, an air gap may be provided between magnetic component 52 and each of magnetic columns 53 and 54. In particular embodiments, magnetic component 52 can be located between magnetic columns 53 and 54. Optionally, magnetic component 52 may be arranged in the same way as the first magnetic component (e.g., 51), and the second magnetic component (e.g., 52) and the first magnetic component can be symmetrical. Also, the overlapping surface of the magnetic column and the first magnetic component, and the overlapping surface of the magnetic column and the second magnetic component, can be symmetrical. The second magnetic component may also have other structures (see, e.g., FIG. 3).

In particular embodiments, the largest surfaces in the first and second magnetic components can both be planes, and the central axes of the two magnetic columns along the same direction may be parallel. For example, the central axes of the two magnetic columns along the same direction may not be parallel. For example, the magnetic column can be an integral column. As another example, the magnetic column can include at least two sub-columns, and an air gap may be arranged between two adjacent sub-columns.

Referring now to FIG. 7, shown is a schematic structural diagram of a sixth example magnetic structure, in accordance with embodiments of the present invention. In this particular example, magnetic structure 60 can include magnetic component 61, magnetic component 62, and two magnetic columns 63 and 64. At least one of two magnetic columns 63 and 64 can be wound with one or more windings, and two magnetic columns 63 and 64 may form a magnetic flux loop with magnetic component 61 and magnetic component 62. Magnetic component 61 can be located between two magnetic columns 63 and 64. An air gap may be provided between each of two magnetic columns 63 and 64 and magnetic component 61. The overlapping surface of the first magnetic component (e.g., 61) and the magnetic column can be a combination of one or more curved surfaces and one or more planes.

In this particular example, the portion of the overlapping surface that is a plane may be perpendicular to reference surface 600, and reference surface 600 can be perpendicular to the central axes of the two magnetic columns and pass through the two magnetic columns. In other examples, the portion of the overlapping surface that is a plane may intersect with the reference surface, and the included angle between the overlapping surface and the reference surface can be in a range of 5°-150°.

In particular embodiments, magnetic component 61 can include a first plane, a first curved surface and a second curved surface connected with the first plane, a second plane, and a third curved surface and a fourth curved surface connected with the second plane. The first curved surface, the first plane, and the second curved surface may form a concave surface. The third curved surface, the second, and the fourth curved surface may form a concave surface. Magnetic column 63 can include a third plane, a fifth curved surface and a sixth curved surface connected with the third plane. The fifth curved surface, the third plane and the sixth curved surface may form a convex surface. Magnetic column 64 can include a fourth plane, a seventh curved surface and an eighth curved surface connected with the fourth plane. The seventh curved surface, the fourth plane, and the eighth curved surface may form a convex surface. The first curved surface, the first plane, and the second curved surface may respectively be overlapped with part of the fifth curved surface, part of the third plane, and part of the sixth curved surface. The third curved surface, the second plane, and the fourth curved surface may respectively be overlapped with part of the seventh curved surface, part of the fourth plane, and part of the eighth curved surface. In particular embodiments, the overlapping surface of the first magnetic component and one of two magnetic columns can be a combination of one or more curved surfaces and one or more planes. Also, the overlapping surface of the first magnetic component and the other of two magnetic columns may have other structures (see, e.g., the plane shown in FIG. 3).

In particular embodiments, magnetic columns 63 and 64 can be located above magnetic component 62, and magnetic component 61 may be located between two magnetic columns 63 and 64. Magnetic component 62 and two magnetic columns 63 and 64 may form a U-shaped magnetic core, and magnetic component 61 can be an I-shaped magnetic core. In particular embodiments, magnetic component 62 and two magnetic columns 63 and 64 can be integrated. In other examples, an air gap may be provided between magnetic component 62 and each of two magnetic columns 63 and 64. In particular embodiments, magnetic component 62 can be located between magnetic columns 63 and 64. Optionally, magnetic component 62 may be arranged in the same way as magnetic component 61. The second magnetic component (e.g., 62) and the first magnetic component (e.g., 61) may be symmetrical, and the overlapping surface of the first magnetic component and one of the two magnetic columns and the overlapping surface of the second magnetic component and the other of the two magnetic columns can be symmetrical. The second magnetic component may also have other structures (see, e.g., FIG. 3).

In particular embodiments, the largest surfaces in the first and second magnetic components can be planes, and the central axes of the two magnetic columns along the same direction may be parallel. In particular embodiments, the central axes of the two magnetic columns along the same direction may not be parallel. For example, the magnetic column can be one column. Also for example, the magnetic column can include at least two sub-columns, and an air gap may be arranged between two adjacent sub-columns.

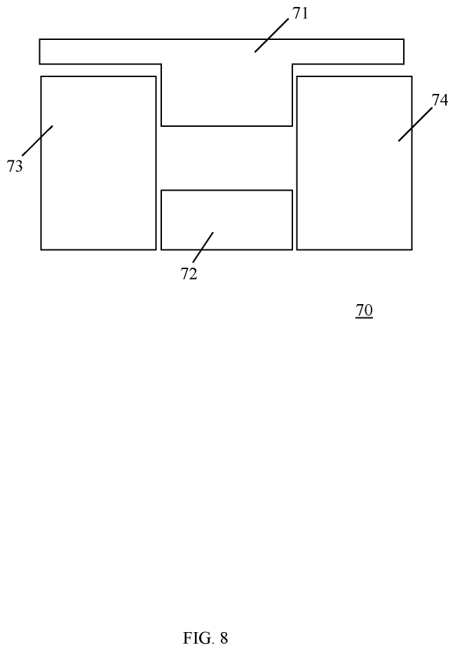

Referring now to FIG. 8, shown is a schematic sectional diagram of a seventh example magnetic structure, in accordance with embodiments of the present invention. In this particular example, magnetic structure 70 can include magnetic component 71, magnetic component 72, and two magnetic columns 73 and 74. At least one of two magnetic columns 73 and 74 can be wound with one or more windings, and two magnetic columns 73 and 74 may form a magnetic flux loop with magnetic components 71 and 72. A first part of the first magnetic component (e.g., 71) can be located between two magnetic columns 73 and 74, and a second part of the first magnetic component can be located above magnetic columns 73 and 74.

In particular embodiments, the first overlapping surface of the first part of the first magnetic component and the magnetic column can be perpendicular to the reference plane. The second overlapping surface of the second part of the first magnetic component and the magnetic column may be parallel to the reference plane. The reference plane can be perpendicular to the central axes of the two magnetic columns and pass through the two magnetic columns. In another example, the first overlapping surface between the first part of the first magnetic component and the magnetic column can intersect with the reference surface with an included angle in a range of 5°-150°. The second overlapping surface between the second part of the first magnetic component and the magnetic column can be parallel to the reference surface. In addition, the second part of the first magnetic component can be made relatively thin, in order to meet flattening requirements.

In particular embodiments, magnetic component 72 can be located between magnetic columns 73 and 74, and part of magnetic component 71 may be located between two magnetic columns 73 and 74. Magnetic component 72 and two magnetic columns 73 and 74 may form a U-shaped magnetic core, and magnetic component 71 can be a T-shaped magnetic core. In particular embodiments, magnetic component 72 may be located between magnetic columns 73 and 74. In particular embodiments, magnetic component 72 can be located below magnetic columns 73 and 74. In particular embodiments, the second magnetic component (e.g., 72) may have the same structure as the second magnetic component in FIG. 3. In another example, the second magnetic component may have other structures (see, e.g., FIG. 5). For example, magnetic component 72 may have the same arrangement as the first magnetic component (e.g., 71), and the first and second magnetic components can be symmetrical. The overlapping surface of the first magnetic component and the magnetic column, and the overlapping surface of the second magnetic component and the magnetic column, can be symmetrical.

In particular embodiments, an air gap may be provided between magnetic component 72 and each of two magnetic columns 73 and 74. In other examples, magnetic component 72 and two magnetic columns 73 and 74 can be integrated. In particular embodiments, the largest surfaces in the first and second magnetic components can be planes, and the central axes of the two magnetic columns along the same direction may be parallel. For example, the central axes of the two magnetic columns along the same direction may not be parallel. For example, the magnetic column can be one column. Also for example, the magnetic column can include at least two sub-columns, and an air gap may be arranged between two adjacent sub-columns.

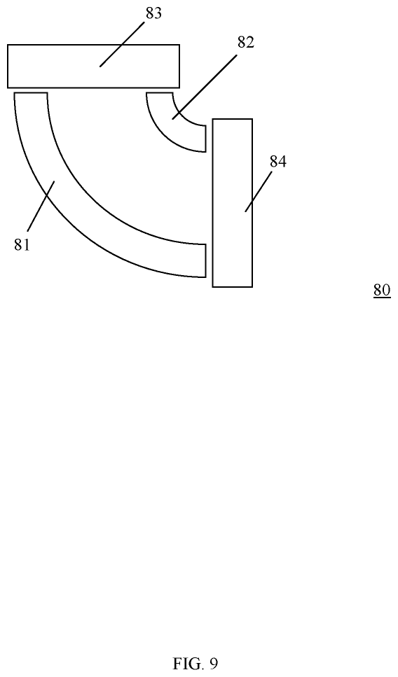

Referring now to FIG. 9, shown is a schematic sectional diagram of an eighth example magnetic structure, in accordance with embodiments of the present invention. In this particular example, magnetic structure 80 can include magnetic component 81, magnetic component 82, and two magnetic columns 83 and 84. At least one of two magnetic columns 83 and 84 can be wound with one or more windings, and two magnetic columns 83 and 84 may form a magnetic flux loop with magnetic components 81 and 82. Magnetic component 81 can be located between two magnetic columns 83 and 84. An air gap may be provided between each of two magnetic columns 83 and 84 and magnetic component 81. In other examples, a first part of the first magnetic component can be located between the two magnetic columns, and a second part of the first magnetic component may be located above the two magnetic columns.

Magnetic components 81 and 82 can be partially annular. The length of the partial annular of magnetic component 81 can be greater than that of the partial annular of magnetic component 82, the cross-section of two magnetic columns 83 and 84 can be rectangular, and the central axes of magnetic columns 83 and 84 may intersect. In particular embodiments, magnetic component 82 can be located between magnetic columns 83 and 84. For example, magnetic component 82 may have the same arrangement as magnetic component 81. In other embodiments, magnetic columns 83 and 84 can be located above magnetic component 82. In particular embodiments, an air gap may be provided between magnetic component 82 and each of magnetic columns 83 and 84. For example, magnetic component 82 and two magnetic columns 83 and 84 can be integrated. For example, the magnetic column can be one column. In other examples, the magnetic column can include at least two sub-columns, and an air gap may be arranged between two adjacent sub-columns.

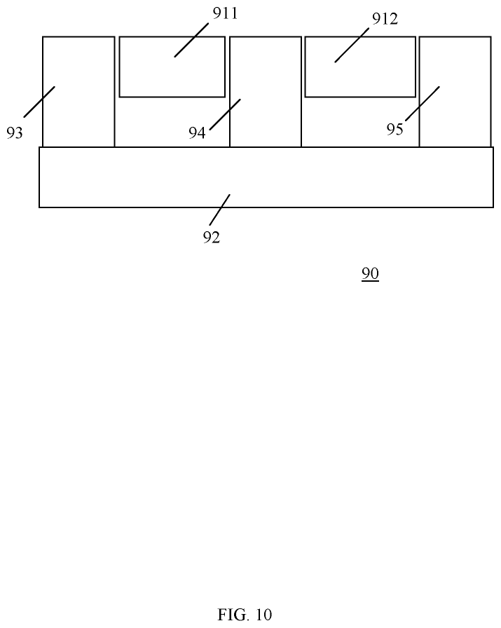

Referring now to FIG. 10, shown is a schematic sectional diagram of a ninth example magnetic structure, in accordance with embodiments of the present invention. In this particular example, magnetic structure 90 can include “first” magnetic components 911 and 912, “second” magnetic component 92, and three magnetic columns 93, 94, and 95. At least one of the three magnetic columns 93, 94, and 95 may be wound with one or more windings, and magnetic columns 93 and 94 may form a magnetic flux loop with magnetic component 911 and a part of magnetic component 92. Magnetic columns 94 and 95 may form a magnetic flux loop with magnetic component 912 and another part of magnetic component 92. For example, magnetic component 911 can be located between magnetic columns 93 and 94, and magnetic component 912 may be located between magnetic columns 94 and 95. An air gap can be arranged between the magnetic column and the first magnetic component.

In particular embodiments, the overlapping surface of the first magnetic component and the magnetic column is a plane. The overlapping surface may be perpendicular to the reference surface, and the reference surface can be perpendicular to the central axes of the two magnetic columns and pass through the two magnetic columns. In addition, the flow direction of magnetic flux in the air gap can be the same as that in the first magnetic component, but different from that in the magnetic column. Thus, the distribution of magnetic flux in the first magnetic component can essentially be uniform, and magnetic flux accumulation may occur on the magnetic column. The magnetic flux of the magnetic column can be uniformly distributed by increasing the width of the magnetic column. In addition, the thickness of the first magnetic component may not be changed, thus being beneficial to flattening, and can be applied to application having strict height restrictions.

In particular embodiments, magnetic columns 93, 94, and 95 may be located above magnetic component 92, magnetic component 911 may be located between magnetic columns 93 and 94, and magnetic component 912 can be located between magnetic columns 94 and 95. A part of magnetic component 92 and magnetic columns 93 and 94 may form a U-shaped core. Magnetic component 911 can be an I-shaped core. The other part of magnetic component 92 and magnetic columns 94 and 95 may form a U-shaped core. Also, magnetic component 912 can be an I-shaped core. That is, magnetic component 92, magnetic columns 93 and 94, and magnetic column 95 may form an E-shaped magnetic core. Here, for the convenience of indicating that the magnetic core structure of particular embodiments can be extended to three or more magnetic flux loops, it is described as a plurality of U-shapes. In other examples, the magnetic structure can also include more than three magnetic columns, so the number of the corresponding first magnetic components can be the number of magnetic columns minus 1, and with an overlapping mode similar to this examples.

In particular embodiments, magnetic components 92, 93, 94, and 95 can be integrated. In particular embodiments, magnetic component 92 and magnetic columns 93, 94, and 95 may be provided with air gaps. In other examples, magnetic component 92 can be divided into first and second portions, and the first magnetic component portion can be located between magnetic columns 93 and 94, and the second magnetic component portion can be located between magnetic columns 94 and 95. Optionally, the second magnetic component (e.g., 92) may have the same arrangement as the first magnetic components 911 and 912. For example, the first magnetic component portion and magnetic component 911 can be symmetrical, the second magnetic component portion and magnetic component 912 may be symmetrical. Also, the overlapping surface of the magnetic column and the first magnetic component can be symmetrical with the overlapping surface of the magnetic column and the second magnetic component.

In particular embodiments, the largest surfaces in the first and second magnetic components can be planes, and the central axes of the two magnetic columns along the same direction may be parallel. In other examples, the central axes of the two magnetic columns along the same direction may not be parallel. For example, the magnetic column can be one column. In other examples, the magnetic column can include at least two sub-columns, and an air gap may be arranged between two adjacent sub-columns. This particular example, as an extension of the example of FIG. 2, shows multiple magnetic flux loops, and other embodiments as described herein can be similarly extended.

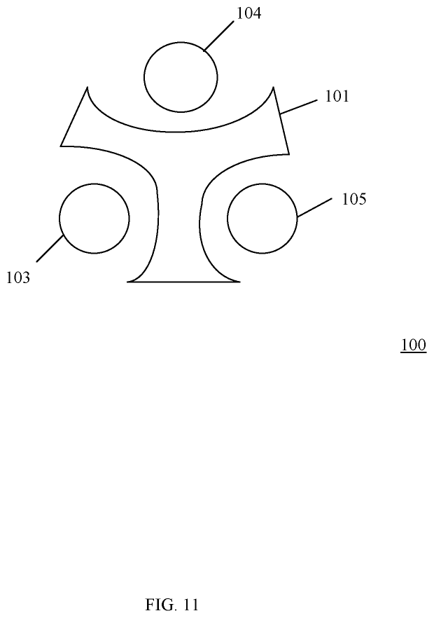

Referring now to FIG. 11, shown is a top view of a tenth example magnetic structure, in accordance with embodiments of the present invention. In this particular example, magnetic structure 100 can include magnetic component 101, a second magnetic component (not shown), and three magnetic columns 103, 104, and 105. At least one of the three magnetic columns 103, 104, and 105 can be wound with one or more winding. The first part of magnetic component 101 can be located between magnetic columns 103 and 104, the second part of magnetic component 101 may be located between magnetic columns 103 and 105, and the third part of magnetic component 101 can be located between magnetic columns 104 and 105. Magnetic columns 103 and 104, part of magnetic component 101 and part of the second magnetic component may form a magnetic flux loop. Magnetic columns 103 and 105, part of magnetic component 101 and part of the second magnetic component may form a magnetic flux loop. Also, magnetic columns 104 and 105, part of magnetic component 101, and part of the second magnetic component may form a magnetic flux loop. An air gap may be arranged between the magnetic column and the first magnetic component.

In particular embodiments, magnetic component 101 and the second magnetic component may be symmetrical. In other examples, the second magnetic component 102 may be located below magnetic columns 103, 104, and 105. In particular embodiments, the top view of magnetic columns 103, 104, and 105 is circular. For each flux loop, a first part of magnetic component 101 can be located between magnetic columns 103 and 104, and a second part of magnetic component 101 can be located on the same side of two magnetic columns 103 and 104. Also, magnetic component 101 may overlap with both the magnetic columns. In other examples, the first magnetic component (e.g., 101) can be located between magnetic columns, and the number of magnetic columns can be greater than 3.

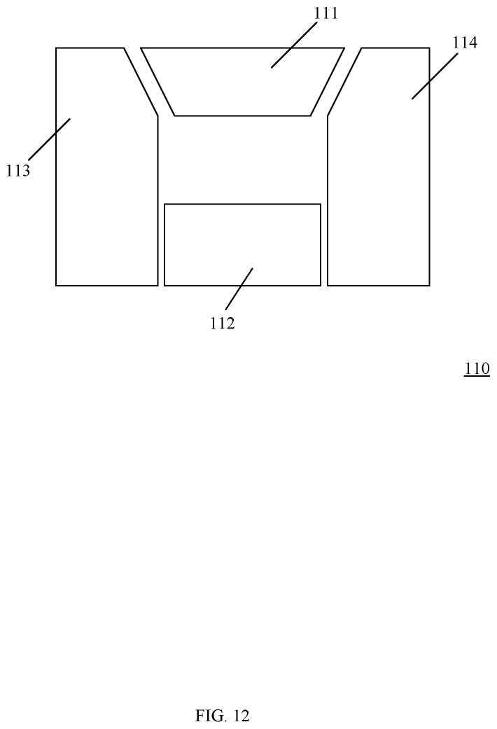

Referring now to FIG. 12, shown is a schematic sectional diagram of an eleventh example magnetic structure, in accordance with embodiments of the present invention. For example, the first magnetic component of the magnetic structure can be as shown in FIG. 4, and the second magnetic component as shown in FIG. 3, in order to obtain the magnetic structure shown in FIG. 12. The position of the air gap in particular embodiments indicates that the two parts are not direct contact, but can be in contact with other materials besides air or other gases. In some embodiments, the first magnetic component, the second magnetic component, and the magnetic column can be integrally formed.

Particular embodiments also provide a magnetic element, which can include any of the above magnetic structures, and at least one group of wires, at least one group of conductive frames, at least one group of wire leads, or at least one group of printed-circuit boards (PCBs). The wires, conductive frames, wire leads, and/or PCB boards, can be used for forming the winding. In addition, magnetic element can be an inductor or a transformer.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. A magnetic structure, comprising:
a) a first magnetic component and a second magnetic component;
b) two magnetic columns configured to form a magnetic flux loop with at least part of the first magnetic component and at least part of the second magnetic component, wherein at least one of the two magnetic columns is wound with one or more windings; and
c) wherein the at least part of the first magnetic component is located between the two magnetic columns.

2. The magnetic structure of claim 1, wherein overlapping surfaces of the first magnetic component and the magnetic column are matched.

3. The magnetic structure of claim 2, wherein the overlapping surface of the first magnetic component and the magnetic column is configured as a curved surface, a plane, or a combination of one or more curved surfaces and one or more planes.

4. The magnetic structure of claim 3, wherein:
a) when the overlapping surface is configured as a plane or a combination of one or more curved surfaces and one or more planes, at least part of an area where the overlapping surface is a plane that intersects with a reference surface; and
b) the reference surface is perpendicular to central axes of the two magnetic columns and passes through the two magnetic columns.

5. The magnetic structure of claim 4, wherein an included angle between the overlapping surface and the reference surface is in a range of 5°-150°.

6. The magnetic structure of claim 3, wherein at least part of an area where the overlapping surface between at least one magnetic column and the first magnetic component is plane is perpendicular to the reference surface.

7. The magnetic structure of claim 6, wherein:
a) the first magnetic component comprises a first plane and a second plane, a first of the two magnetic columns comprises a third plane, and a second of the two magnetic columns comprises a fourth plane; and
b) the first plane overlaps with a part of the second plane, and the second plane overlaps with a part of the fourth plane.

8. The magnetic structure of claim 4, wherein:
a) when the area where the overlapping surface is a plane is not perpendicular to the reference surface, the first magnetic component comprises a first inclined plane and a second inclined plane, a first of the two magnetic columns comprises a third inclined plane, and a second of the two magnetic columns comprises a fourth inclined plane; and
b) the first inclined plane overlaps with the third inclined plane, and the second inclined plane overlaps with the fourth inclined plane.

9. The magnetic structure of claim 3, wherein:
a) the first magnetic component comprises a first convex/concave surface;
b) the second magnetic component comprises a second convex/concave surface;
c) a first of the two magnetic columns comprises a third concave/convex surface;
d) a second of the two magnetic columns comprises a fourth concave/convex surface;
e) the first convex/concave surface overlaps with the third concave/convex surface; and
f) the second convex/concave surface overlaps with the fourth concave/convex surface.

10. The magnetic structure of claim 9, wherein:
a) the first magnetic component comprises a first plane, a first curved surface and a second curved surface connected with the first plane, a second plane, a third curved surface and a fourth curved surface connected with the second plane;
b) the first curved surface, the first plane, and the second curved surface form a concave surface;
c) the third curved surface, the second plane, and the fourth curved surface form a concave surface;
d) the one of the two magnetic columns comprises a third plane, a fifth curved surface, and a sixth curved surface connected with the third plane;
e) the fifth curved surface, the third plane, and the sixth curved surface form a convex surface;
f) the second of the two magnetic columns comprises a fourth plane, a seventh curved surface, and an eighth curved surface connected with the fourth plane;
g) the seventh curved surface, the fourth plane, and the eighth curved surface form a convex surface;
h) the first curved surface, the first plane and the second curved surface respectively overlap with part of the fifth curved surface, part of the third plane, and part of the sixth curved surface; and
i) the third curved surface, the second plane, and the fourth curved surface respectively overlap with part of the seventh curved surface, part of the fourth plane, and part of the eighth curved surface.

11. The magnetic structure of claim 9, wherein:
a) the first magnetic component comprises a first curved surface and a second curved surface, one of the two magnetic columns comprises a third curved surface, and the other of the two magnetic columns comprises a fourth curved surface;
b) the first curved surface overlaps with the third curved surface, and the second curved surface overlaps with the fourth curved surface, a first of the first curved surface and the third curved surface is a concave surface, and a second of the first curved surface and the third curved surface is a convex surface; and
c) a first of the second curved surface and the fourth curved surface is a concave surface, and a second of the second curved surface and the fourth curved surface is a convex surface.

12. The magnetic structure of claim 1, wherein the first magnetic component and the second magnetic component are both partially annular, and a central axes of the two magnetic columns intersects.

13. The magnetic structure of claim 1, wherein one of:
a) the first magnetic component is located between the two magnetic columns; and
b) a first part of the first magnetic component is located between the two magnetic columns, and a second part of the first magnetic component is located above the two magnetic columns.

14. The magnetic structure of claim 1, wherein a first part of the first magnetic component is located between the two magnetic columns, and a second part of the first magnetic component is located on the same side of the two magnetic columns and is overlapped with both of the two magnetic columns.

15. The magnetic structure of claim 14, wherein:
a) the magnetic structure further comprises a third magnetic column;
b) a first part of the first magnetic component is located between the two magnetic columns;
c) a second part of the first magnetic component is located between one of the two magnetic columns and the third magnetic column; and
d) a third part of the first magnetic component is located between the other of the two magnetic columns and the third magnetic column.

16. The magnetic structure of claim 1, wherein one of:
a) the second magnetic component is located under the two magnetic columns; and
b) at least part of the second magnetic component is located between the two magnetic columns.

17. The magnetic structure of claim 1, wherein at least one of:
a) there is no direct contact between the first magnetic component and the magnetic column; and
b) there is no direct contact between the second magnetic component and the magnetic column.

18. The magnetic structure of claim 1, wherein one of:
a) the second magnetic component and the magnetic column are integrally formed; and
b) the first magnetic component, the second magnetic component, and the magnetic column are integrally formed.

19. The magnetic structure of claim 1, further comprising another first magnetic component and a third magnetic column, wherein at least part of the another first magnetic component is located between one of the two magnetic columns and the third magnetic column.

20. A magnetic element, comprising the magnetic structure in claim 1, and further comprising at least one group of wires, at least one group of conductive frames, at least one group of wire leads, or at least one group of PCBs, being configured to form one or more windings.
